(19) United States
(12) Patent Application Publication
(10) Pub. No.: US 2008/0074462 A1
(43) Pub. Date: Mar. 27, 2008

(54) Image forming apparatus

(75) Inventor: Takashi Hirakawa, Kanagawa-ken (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/902,311

(22) Filed: Sep. 20, 2007

(30) Foreign Application Priority Data
Sep. 22, 2006 (JP) 2006-257797

(51) Int. Cl. B41J 2/165

(52) U.S. Cl. 347/28

(57) ABSTRACT

The image forming apparatus includes: a conveyance device which conveys an ejection receiving medium along a prescribed conveyance path; a recording head which deposits ink on the conveyed ejection receiving medium to form an image, the ink containing solvent and coloring material; and a liquid absorbing member which is made of a porous body having pores, the liquid absorbing member coming into contact with the ink deposited on the ejection receiving medium so that an excess of the solvent is removed, wherein: the conveyance device conveys the ejection receiving medium at a conveyance speed from 100 mm/s through 600 mm/s while the liquid absorbing member is in contact with the deposited ink; and the pores of the liquid absorbing member has a pore diameter from 10 μm through 100 μm.

### BACKGROUND OF THE INVENTION

1. Field of the Invention

The present invention relates to an image forming apparatus, and more particularly, to an image forming apparatus which removes excess solvent by making a porous body come into contact with ink deposited on an ejection receiving medium.

2. Description of the Related Art

An image forming apparatus has been known which forms an image on an ejection receiving medium by using liquid ink, such as an inkjet recording apparatus. In this image forming apparatus, if liquid (ink solvent) remains on the ejection receiving medium after the formation of an image, then this can give rise to image degradation (image defects), transfer to the reverse side, cockling, and the like. Therefore, in the image forming apparatus which uses liquid ink, it is necessary to remove the liquid remaining on the ejection receiving medium immediately after the ink droplets are deposited onto the ejection receiving medium. The liquid needs to be removed especially in an image forming apparatus of a type which insolubilizes the coloring material contained in the ink or which causes the coloring material to aggregate, by causing a treatment liquid and the ink to react with each other on the ejection receiving medium, since the amount of liquid adhering to the ejection receiving medium is large in such a type of image forming apparatus compared to another type.

Japanese Patent Application Publication No. 2001-179959 discloses that an image forming apparatus which includes an ink absorbing body disposed on the downstream side of the recording head and which absorbs the excess solvent by means of this ink absorbing body. The ink absorbing body described in Japanese Patent Application Publication No. 2001-179959 includes: a main frame formed in a cylindrical shape; a liquid solvent absorbing body which is provided on the outer circumference of the main frame and which absorbs only the liquid solvent of the ink; and a porous separating member (parting (releasing) member) which has separating characteristics (characteristics whereby the porous separating member tends to be separated (released) from the colorant) with respect to the colorant and which is provided on the outer circumference of the liquid solvent absorbing body. In this image forming apparatus, the ink absorbing body makes contact with the ink deposited on the ejection receiving medium and absorbs the excess solvent from same.

Furthermore, Japanese Patent Application Publication No. 2005-271400 discloses an image forming apparatus which includes a liquid absorbing apparatus disposed on the downstream section of the recording head and which absorbs excess solvent by means of this liquid absorbing apparatus. The liquid absorbing apparatus disclosed in Japanese Patent Application Publication No. 2005-271400 is constituted of a liquid absorbing roll in which the outer circumferential surface of a metal shaft is coated with an absorbing layer (porous body or fibrous body) and a hydrophilic absorbing layer in this order, or an endless liquid absorbing belt on which an absorbing body layer and a hydrophilic absorbing layer are stacked, or a liquid absorbing rolled paper on which a liquid permeation preventing layer, a liquid retaining layer, a liquid absorbing layer and a hydrophilic absorbing layer are stacked. The excess solvent is absorbed by placing the liquid absorbing apparatus (constituted of the liquid absorbing roll or the endless liquid absorbing belt or the liquid absorbing rolled paper) in contact with the ink deposited on the ejection receiving medium.

However, in the technologies disclosed in Japanese Patent Application Publication Nos. 2001-179959 and 2005-271400, the focus is placed only on removing excess solvent, and hence there is a possibility that coloring material is absorbed together with the solvent, and coloring material adheres to the surface of the porous body.

### SUMMARY OF THE INVENTION

The present invention has been contrived in view of these circumstances, an object thereof being to provide an image forming apparatus in which excess solvent can be removed with good efficiency, while preventing the adherence of coloring material to a liquid absorbing member.

In order to attain the aforementioned object, the present invention is directed to an image forming apparatus, including: a conveyance device which conveys an ejection receiving medium along a prescribed conveyance path; a recording head which deposits ink on the conveyed ejection receiving medium to form an image, the ink containing solvent and coloring material; and a liquid absorbing member which is made of a porous body having pores, the liquid absorbing member coming into contact with the ink deposited on the ejection receiving medium so that an excess of the solvent is removed, wherein: the conveyance device conveys the ejection receiving medium at a conveyance speed from 100 mm/s through 600 mm/s while the liquid absorbing member is in contact with the deposited ink; and the pores of the liquid absorbing member has a pore diameter from 10 μm through 100 μm.

According to this aspect of the present invention, in a case where the excess solvent is removed by making the liquid absorbing member come into contact with the ink deposited on the ejection receiving medium and constituting the image formed by the recording device, the conveyance device conveys the ejection receiving medium at a conveyance speed from 100 mm/s through 600 mm/s while the liquid absorbing member is in contact with the deposited ink; and the pores of the liquid absorbing member has a pore diameter from 10 μm through 100 μm. By this means, it is possible to remove the excess solvent with good efficiency, while preventing the coloring material from adhering to the liquid absorbing member.

Preferably, a percentage of the coloring material to the solvent is within a range of 2% through 10% in the ink before the liquid absorbing member comes into contact with the ink.

In this aspect of the present invention, since the percentage of the coloring material to the solvent is set within the range of 2% to 10% in the ink before the liquid absorbing member comes into contact with the ink, then it is possible to remove the excess solvent with good efficiency, while preventing the coloring material from adhering to the liquid absorbing member.

Preferably, the image forming apparatus further includes a treatment liquid deposition device which deposits treatment liquid on the conveyed ejection receiving medium to form a film of the treatment liquid, the treatment liquid causing the coloring material in the ink to be aggregated, the film of the treatment liquid having a thickness of 3 μm through 10 μm.

According to this aspect of the present invention, since the film of the treatment liquid has a thickness of 3 μm through 10 μm, then it is possible to remove the excess solvent with good efficiency, while preventing the coloring material from adhering to the liquid absorbing member.

Preferably, the liquid absorbing member removes the excess of the solvent of the ink and the treatment liquid so that, after removing the excess of the solvent, the solvent remains on the ejection receiving medium to form a film having a thickness not less than the thickness of the film of the treatment liquid.

According to this aspect of the present invention, the liquid absorbing member removes the excess of the solvent of the ink and the treatment liquid so that, after removing the excess of the solvent, the solvent remains on the ejection receiving medium to form a film having a thickness not less than the thickness of the film of the treatment liquid By this means, it is possible to suppress the adherence of coloring material to the liquid absorbing member reliably.

In the present invention directed to an image forming apparatus, it is possible to remove the excess solvent with good efficiency, while preventing the coloring material from adhering to the liquid absorbing member.

### BRIEF DESCRIPTION OF THE DRAWINGS

The nature of this invention, as well as other objects and benefits thereof, will be explained in the following with reference to the accompanying drawings, in which like reference characters designate the same or similar parts throughout the figures and wherein:

FIG. 1 is a general schematic drawing showing a general view of an inkjet recording apparatus of intermediate transfer body type according to an embodiment of the present invention;

FIG. 2 is a plan diagram showing an ejection surface of a recording head;

FIG. 3 is a cross-sectional view along line 3-3 of the recording head in FIG. 2;

FIG. 4 is a principal block diagram showing the system composition of the inkjet recording apparatus;

FIG. 5 is a conceptual diagram illustrating solvent absorption by means of a solvent absorption roller;

FIG. 6 is a graph showing the relationship between the conveyance speed of the intermediate transfer body and the remaining amount of the solvent;

FIG. 7 is a graph showing the relationship between the conveyance speed of the intermediate transfer body and the remaining amount of the solvent, when the droplet ejection volume is varied;

FIGS. 8A to 8C are illustrative diagrams showing the relationship between the deposition thickness of the treatment liquid and the state of the aggregated coloring material;

FIGS. 9A to 9D are illustrative diagrams showing the relationship between the residual amount of solvent and the adherence of coloring material to the surface of the porous body;

FIG. 10A is a cross-sectional diagram showing a cross section of a solvent absorbing roller according to another example; and

FIG. 10B is a plan view diagram showing the solvent absorbing roller shown in FIG. 10A.

### DETAILED DESCRIPTION OF THE PREFERRED EMBODIMENTS

The description below relates to an inkjet recording apparatus of intermediate transfer type forming an image forming apparatus according to an embodiment of the present invention.

The inkjet recording apparatus of intermediate transfer type forms an image on an intermediate transfer body by means of a recording head, and then transfers the image formed on the intermediate transfer body to a recording medium, thereby forming a prescribed image on the recording medium.

In the inkjet recording apparatus of the intermediate transfer type according to the present embodiment, an ink and a treatment liquid are used to form an image on the intermediate transfer body. The ink usable in the present embodiment includes an ink containing a solvent-insoluble material (such as coloring material), such as a pigment-based ink. The treatment liquid usable in the present embodiment has properties whereby it reacts with the ink and has the function of aggregating the solvent-insoluble material in the ink. By using the treatment liquid, it is possible to prevent depositing interference between ink droplets deposited the intermediate transfer body, and it is possible to form an image of high quality on the intermediate transfer body.

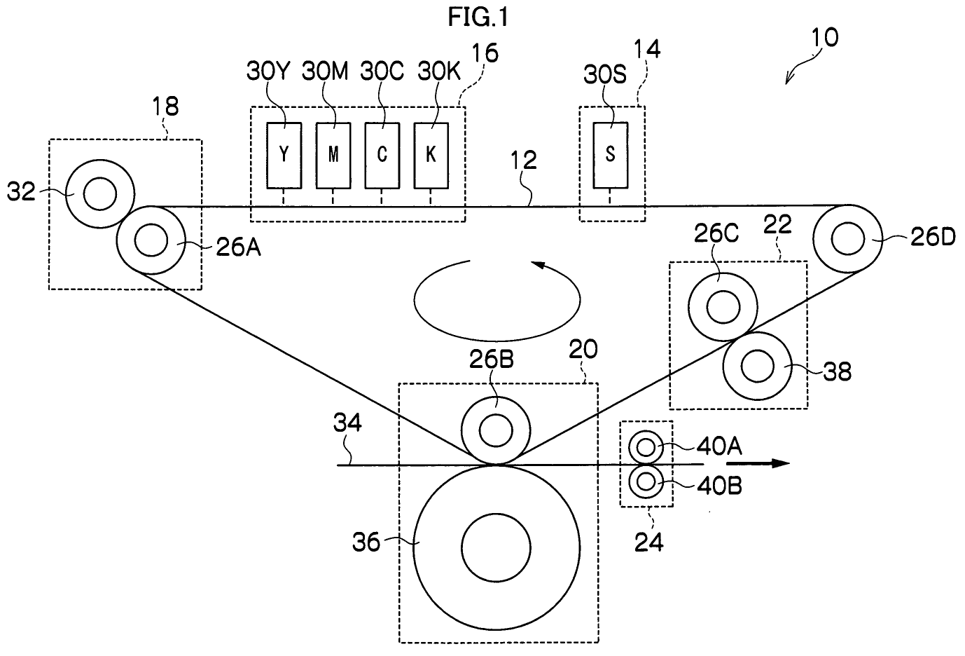

FIG. 1 is a schematic drawing which shows the approximate composition of the inkjet recording apparatus of intermediate transfer type according to an embodiment of the present invention.

As shown in FIG. 1, this intermediate transfer type of inkjet recording apparatus 10 is principally constituted of: an intermediate transfer body 12 which forms an ejection receiving medium; a treatment liquid supply unit 14 which deposits treatment liquid (S) on the surface (recording surface) of the intermediate transfer body 12; a marking unit 16 (corresponding to a “recording head”) which forms an image by ejecting inks of respective colors of black (K), cyan (C), magenta (M) and yellow (Y) on the recording surface of the intermediate transfer body 12 onto which the treatment liquid has been deposited; a solvent removal unit 18 which removes excess solvent of the ink deposited on the recording surface of the intermediate transfer body 12; a transfer unit 20 which transfers the image formed on the recording surface of the intermediate transfer body 12 to the surface (recording surface) of a recording medium 34; a cleaning unit 22 which cleans the recording surface of the intermediate transfer body 12 after transfer; and an image fixing unit 24 which fixes the image having been transferred to the recording medium 34.

The intermediate transfer body 12 is constituted of an endless belt having a prescribed width. This intermediate transfer body 12 is wound about four rollers 26A to 26D which are disposed in prescribed positions, and the intermediate transfer body 12 is supported and guided by these four rollers 26A to 26D so as to travel along a prescribed conveyance path.

The four rollers 26A to 26D are disposed respectively in the prescribed positions in such a manner that a travel path having an inverted triangular shape is formed as shown in FIG. 1, and at least one of the rollers is connected to an intermediate transfer body drive motor (not illustrated). By driving this intermediate transfer body drive motor, the intermediate transfer body 12 is caused to travel at a prescribed conveyance speed along the inverted triangle-shaped conveyance path, in the direction indicated by the arrow (the counterclockwise direction) in FIG. 1.

The treatment liquid supply unit 14 includes a ejection head (hereinafter, referred to as “treatment liquid head”) 30S which ejects treatment liquid (S) toward the recording surface of the intermediate transfer body 12. This treatment liquid head 30S is constituted by a so-called full line head. The treatment liquid head 30S has a plurality of nozzles arranged through the width corresponding to the intermediate transfer body 12, and the nozzles are arranged on a surface (on the ejection surface) of the treatment liquid head 30S opposing the recording surface of the intermediate transfer body 12. When the intermediate transfer body 12 passes below the treatment liquid head 30S, the treatment liquid is ejected from the nozzles of the treatment liquid head 30S to form a film of treatment liquid with a prescribed thickness (in the present embodiment, a thickness of 3 μm to 10 μm) on the recording surface.

The specific composition of the treatment liquid head 30S disposed in the treatment liquid supply unit 14 is described in detail later, together with the composition of the ink heads 30K, 30C, 30M and 30Y disposed in the marking unit 16.

Furthermore, as described above, the treatment liquid ejected from the treatment liquid supply unit 14 has properties whereby it reacts with the ink, and the function of causing the solvent-insoluble material contained in the ink to aggregate.

The marking unit (recording device) 16 is disposed to the downstream side of the treatment liquid supply unit 14 in terms of the direction of travel of the intermediate transfer body 12. The marking unit 16 includes recording heads (hereinafter, called “ink heads”) 30K, 30C, 30M and 30Y, which eject inks of respective colors of black (K), cyan (C), magenta (M) and yellow (Y) toward the recording surface of the intermediate transfer body 12 on which the treatment liquid has been deposited. Similarly to the treatment liquid head 30S, these ink heads 30K, 30C, 30M and 30Y are also constituted of full line heads. Each of the ink heads 30K, 30C, 30M and 30Y has a plurality of nozzles arranged through the width corresponding to the intermediate transfer body 12, and the nozzles are arranged on the surface (on the ejection surface) which opposes the recording surface of the intermediate transfer body 12. When the intermediate transfer body 12 passes below the ink heads 30K, 30C, 30M and 30Y of the marking unit 16, a prescribed image is formed on the recording surface of the intermediate transfer body 12 by ejecting inks of colors from the ink heads 30K, 30C, 30M and 30Y.

As described above, each of the inks ejected from the ink heads 30K, 30C, 30M and 30Y is an ink such as a pigment-based ink, which contains a solvent-insoluble material. As stated previously, when the ink deposits on the recording surface of the intermediate transfer body 12, the ink reacts with the treatment liquid having been deposited on the recording surface, resulting in the aggregation of the solvent-insoluble material. Consequently, it is possible to prevent the depositing interference between ink droplets and hence images of high quality can be formed on the recording surface of the intermediate transfer body 12.

The solvent removal unit 18 is disposed to the downstream side of the marking unit 16 in terms of the direction of travel of the intermediate transfer body 12. This solvent removal unit 18 has a solvent absorbing roller 32 which makes contact with the ink that has been deposited on the recording surface of the intermediate transfer body 12 and removes the excess solvent. This solvent absorbing roller 32 is made of a porous material having pores of a prescribed pore diameter (in the present embodiment, 10 μm to 100 μm), and it is arranged across the intermediate transfer body 12 from the roller 26A. When the intermediate transfer body 12 passes the solvent removal unit 18, the excess solvent on the recording surface is removed. In other words, when the intermediate transfer body 12 passes the solvent removal unit 18, the solvent absorbing roller 32 makes contact with the recording surface, and the excess solvent is absorbed by the solvent absorbing roller 32 and thereby removed.

In the inkjet recording apparatus 10 according to the present embodiment, the conveyance speed of the intermediate transfer body 12 when the intermediate transfer body 12 passes the solvent absorbing roller 32 is set to be within the range from 100 mm/s through 600 mm/s. This point is described in detail below.

The transfer unit 20 is disposed to the downstream side of the solvent removal unit 18 in terms of the direction of travel of the intermediate transfer body 12. The transfer unit 20 includes a pressurization roller 36 arranged across the intermediate transfer body 12 from the roller 26B. A recording medium 34 is conveyed in the direction of the arrow in FIG. 1 (from left to right) while the recording medium 34 is pinched between the pressurization roller 36 and the intermediate transfer body 12. During the course of this conveyance action, the recording medium 34 is pressed against the intermediate transfer body 12 by the pressurization roller 36 and the image formed on the recording surface of the intermediate transfer body 12 is transferred to the surface (recording surface) of the recording medium 34.

The cleaning unit 22 is disposed on the downstream side of the transfer unit 20 in terms of the direction of travel of the intermediate transfer body 12. This cleaning unit 22 includes a cleaning roller 38 which cleans the recording surface of the intermediate transfer body 12 after transfer. The cleaning roller 38 is constituted by a porous body which is flexible and is impregnated with a cleaning solution, and the cleaning roller 38 is disposed across the intermediate transfer body 12 from the roller 26C. When the intermediate transfer body 12 passes through the cleaning unit 22, the cleaning roller 38 makes contact with the recording surface and residual matter remaining on the recording surface is removed.

The cleaning roller 38 can remove the residual matter at high removal rate by setting the linear speed of the surface of the cleaning roller 38 to be slower or faster than the linear speed of the intermediate transfer body 12. This is because the speed differential between the surface of the cleaning roller 38 and the surface of the intermediate transfer body generates a shearing force at the surface of the intermediate transfer body, and this causes the residual matter to be removed effectively.

The image fixing unit 24 is disposed on the recording medium output side of the transfer unit 20 (the right-hand side in FIG. 1). The image fixing unit 24 includes a pair of fixing rollers 40A and 40B, and the recording medium 34 is conveyed while being pinched between this pair of fixing rollers 40A and 40B. In the course of this conveyance action, the pair of fixing rollers 40A and 40B improve the fixing characteristics of the recorded image on the recording medium 34, by pressurizing and heating the image transferred to the recording medium 34.

Next, the composition of the treatment liquid head 30S disposed in the treatment liquid supply unit 14 and the ink heads 30K, 30C, 30M and 30Y disposed in the marking unit 16 will be described.

The treatment liquid head 30S and the ink heads 30K, 30C, 30M and 30Y all have the same composition, and here, the composition of a recording head 30 will be described as a representative example.

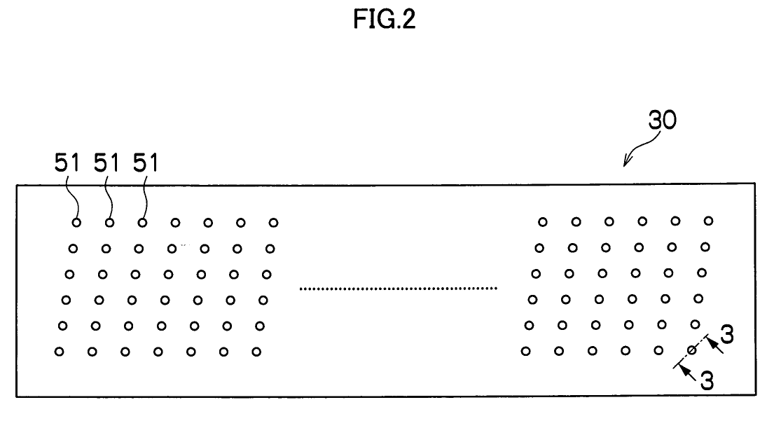

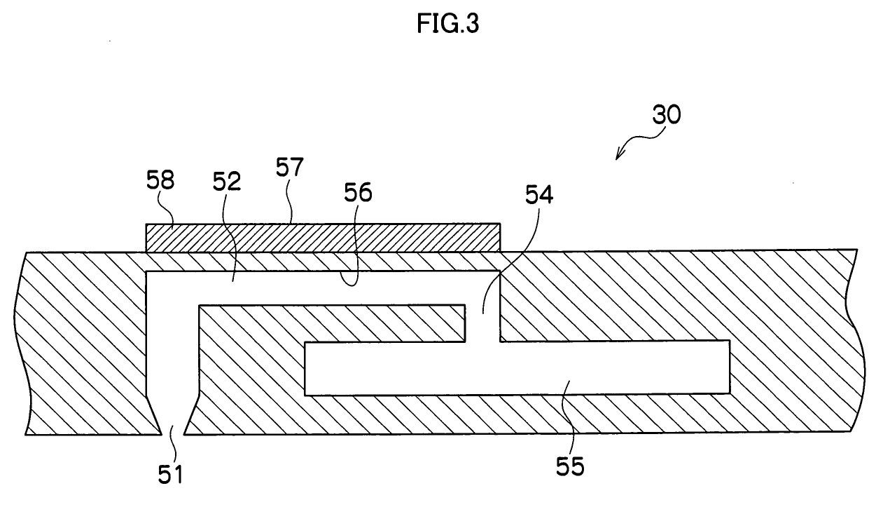

FIG. 2 is a plan diagram showing the ejection surface of the recording head 30. Furthermore, FIG. 3 is a cross-sectional view of the recording head 30 shown in FIG. 2, taken along line 3-3 in FIG. 2. In FIG. 2, the lengthwise direction of the head 30 corresponds to the front/rear direction of the plane of the drawing in FIG. 1.

As described above, the recording head 30 according to the present embodiment is constituted by a full line type of recording head, and the ejection surface of the head is formed with a plurality of ejection ports (nozzles) 51 arranged through a length corresponding to the maximum recording width of the image to be formed on the recording surface of the intermediate transfer body 12.

As shown in FIG. 2, the nozzles 51 are arranged two-dimensionally (in a matrix configuration) following the lengthwise direction of the head and an oblique direction which is not perpendicular to the lengthwise direction of the head, and it is possible to achieve high-resolution image recording on the recording surface of the intermediate transfer body 12 by means of this high-density arrangement of the nozzles.

As shown in FIG. 3, pressure chambers 52 are provided in the recording head 30, and the pressure chambers 52 are provided for the nozzles 51, respectively. A supply port 54 is formed at one end of each of the pressure chambers 52, and the pressure chambers 52 are connected to a common flow channel 55 by means of the supply ports 54. A prescribed liquid (treatment liquid or ink of one of the respective colors) is accumulated in the common flow channel 55, and the liquid is supplied from the common flow channel 55 to the pressure chambers 52, through the corresponding supply ports 54.

One wall of each of the pressure chambers 52 (the upper face in FIG. 3) is constituted of a diaphragm 56, and piezoelectric elements 58 are installed on the diaphragm 56 at positions corresponding to the pressure chambers 52. An individual electrode 57 is provided on the upper surface of each of the piezoelectric elements 58. In the present embodiment, the diaphragm 56 is constituted of a conductive material, and it also serves as a common electrode for the piezoelectric elements 58.

By adopting this composition, when a drive voltage is applied to the piezoelectric element 58, pressure is applied to the liquid in the pressure chamber 52 due to the displacement of the piezoelectric element 58, thereby causing a droplet to be ejected from the corresponding nozzle 51. After ejection, liquid is supplied to the pressure chamber 52 from the common flow channel 55.

In the present embodiment, a piezoelectric type of recording head which performs ejection by using the piezoelectric elements 58 is described as an example, but the implementation of the present invention is not limited to this, and it is also possible, for example, to use other types of recording heads, such as a thermal type of recording head which performs ejection by using electrical to thermal converter elements, such as heaters.

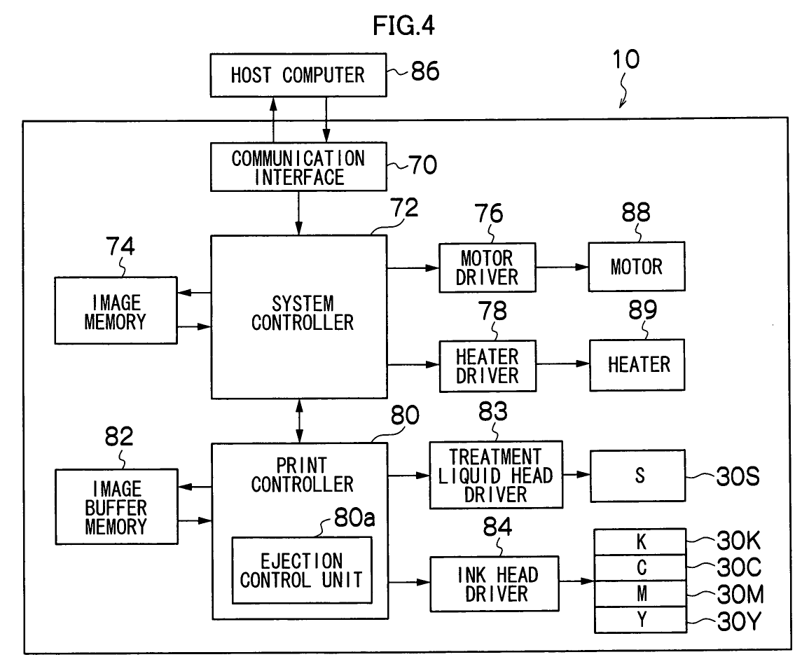

FIG. 4 is a principal block diagram showing the system configuration of the inkjet recording apparatus 10 shown in FIG. 1.

The inkjet recording apparatus 10 includes a communication interface 70, a system controller 72, an image memory 74, a motor driver 76, a heater driver 78, a print controller 80, an image buffer memory 82, a treatment liquid head driver 83, an ink head driver 84, and the like.

The communication interface 70 is an interface unit for receiving image data sent from a host computer 86. A serial interface or a parallel interface may be used as the communication interface 70. A buffer memory (not shown) may be mounted in this portion in order to increase the communication speed.

The image data sent from the host computer 86 is received by the inkjet recording apparatus 10 through the communication interface 70, and is temporarily stored in the image memory 74. The image memory 74 is a storage device for temporarily storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is a control unit for controlling the various sections, such as the communication interface 70, the image memory 74, the motor driver 76, the heater driver 78, and the like. The system controller 72 is constituted by a central processing unit (CPU) and peripheral circuits thereof, and the like, and in addition to controlling communications with the host computer 86 and controlling reading and writing from and to the image memory 74, or the like, it also generates a control signal for controlling the motor (intermediate transfer body drive motor and the like) 88 of the various sections and the heater 89.

The motor driver (drive circuit) 76 drives the motor 88 in accordance with commands from the system controller 72. The heater driver (drive circuit) 78 drives the heater 89 in accordance with commands from the system controller 72.

The print controller 80 has a signal processing function for performing various tasks, compensations, and other types of processing for generating print control signals from the image data stored in the image memory 74 in accordance with commands from the system controller 72 so as to supply the generated print control signal (dot data) to the respective head drivers 83 and 84. Prescribed signal processing is carried out in the print controller 80, and the ejection amount and the ejection timing of the droplets from the respective recording heads 30 (30S, 30K, 30M, 30C, and 30Y) are controlled via the respective head drivers 83 and 84, on the basis of the print data. By this means, prescribed dot size and dot positions can be achieved.

The print controller 80 is provided with the image buffer memory 82; and image data, parameters, and other data are temporarily stored in the image buffer memory 82 when image data is processed in the print controller 80.

The aspect shown in FIG. 4 is one in which the image buffer memory 82 accompanies the print controller 80; however, the image memory 74 may also serve as the image buffer memory 82.

Also possible is an aspect in which the print controller 80 and the system controller 72 are integrated to form a single processor.

The head drivers 83 and 84 (the treatment liquid head driver 83 and the ink head driver 84) generate drive signals for driving the piezoelectric elements 58 (see FIG. 3) of the corresponding recording heads 30 (30S, 30K, 30C, 30M, 30Y), on the basis of the dot data supplied from the print controller 80, and they supply the generated drive signals to the piezoelectric elements 58, accordingly. A feedback control system for maintaining constant drive conditions for the recording heads 30 may be included in the head drivers 83 and 84.

Next, the conveyance conditions of the intermediate transfer body 12 in the solvent removal unit 18, which is one of the characteristic parts of the present invention, will be described.

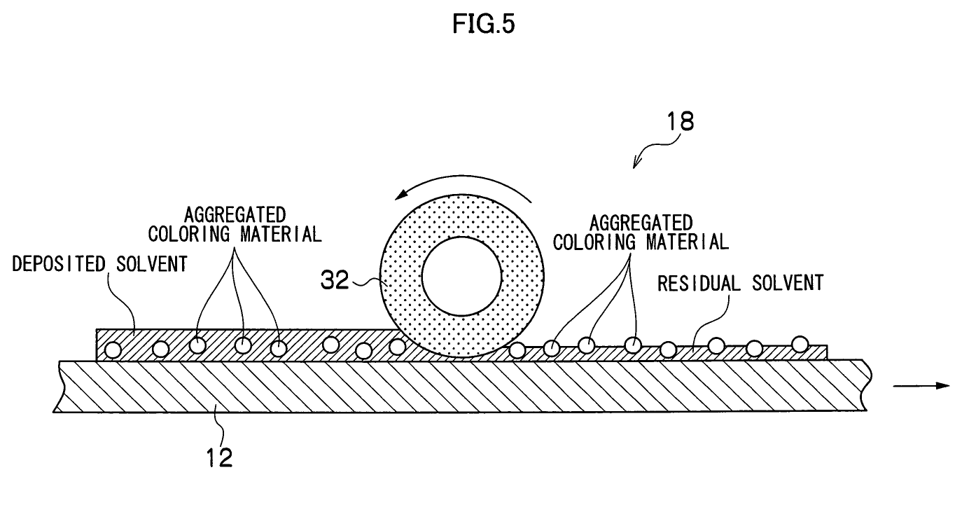

As shown in FIG. 5, in the solvent removal unit 18, by making the solvent absorbing roller 32 come into contact with the recording surface of the traveling intermediate transfer body 12, the excess solvent on the recording surface is absorbed and removed by the solvent absorbing roller 32.

The present inventor discovered problems which may arise when the excess solvent is removed in the solvent removal unit 18 by making the solvent absorbing roller 32 come into contact with the recording surface of the traveling intermediate transfer body 12. More specifically, a problem may occur in that the coloring material adheres to the surface of the solvent absorbing roller 32, or a problem may occur in that the excess solvent will not be absorbed adequately. These problems occur if the conveyance speed of the intermediate transfer body 12 during this action is not set to a suitable value. In other words, if the conveyance speed of the intermediate transfer body 12 is set to an excessively fast speed, then adequate absorption of the excess solvent is not achieved, whereas if it is set to an excessively slow speed, then a problem occur in that coloring material adheres to the surface of the solvent absorbing roller 32.

It was discovered that in order to achieve optimal conveyance conditions, the conveyance speed of the intermediate transfer body 12 is preferably set to be within a range of 100 mm/s to 600 mm/s.

By this means, it is possible to absorb excess solvent effectively, while preventing adherence of coloring material.

Below, the relationship between the conveyance speed of the intermediate transfer body 12 and the adherence of coloring material to the solvent absorbing roller 32 will be described.

Firstly, the following experiment was carried out in order to clarify the relationship between the conveyance speed of the intermediate transfer body 12 and the adherence of coloring material to the solvent absorbing roller 32.

More specifically, the conveyance speed of the intermediate transfer body was varied between 10 mm/s, 50 mm/s, 100 mm/s, 200 mm/s, 600 mm/s and 1000 mm/s, and the state of adherence of coloring material was examined at each of the conveyance speeds.

Furthermore, the size (pore diameter) of the pores in the solvent absorbing roller was varied between 1 μm, 10 μm, 40 μm, 100 μm and 200 μm, under each of the conveyance speed conditions described above, and the state of adherence of coloring material was examined for each of the pore diameters.

The state of adherence of coloring material was evaluated by means of visual evaluation of the remaining amount of coloring material left on the intermediate transfer body after passing the solvent absorbing roller. The criteria for this evaluation were as follows.

A: Remainder rate of 90% to 100% (an adherence rate on the solvent absorbing roller of 10% or less)

B: Remainder rate of 80% to 90% (an adherence rate on the solvent absorbing roller of 10 to 20%)

C: Remainder rate of 70% to 80% (an adherence rate on the solvent absorbing roller of 20 to 30%)

D: Remainder rate of 70% or less (an adherence rate on the solvent absorbing roller of 30% or greater)

Furthermore, the residual amount of solvent on the intermediate transfer body after passing the solvent absorbing roller was evaluated visually at the same time, and if the residual amount of solvent was high, then it was evaluated as “absorption failure”. In Table 1, the symbol “AF” indicates that the “adsorption failure” occurs.

In the experiments, the intermediate transfer type of inkjet recording apparatus 10 described above was used and the solvent absorbing roller 32 having an outer diameter of 70 mm and a void ratio of 30% to 70% was employed. Furthermore, the ink including: water, as a solvent; a surfactant; a water-soluble solvent (for example, glycerine, diethylene glycol, or the like); and a coloring material (e.g., pigment), was used. The ink used had a viscosity of 3 cP and a surface tension of 31 mN/m. The treatment liquid including: water, as a solvent; a surfactant; a water-soluble solvent; and a coloring material aggregating agent, was used. The treatment liquid used had a viscosity of 3 cP and a surface tension of 28 mN/m. The ratio of the treatment liquid to the ink was 1:3, and the total thickness of the treatment liquid and ink having been deposited was 10 μm (treatment liquid of 2.5 μm and ink of 7.5 μm) on the recording surface of the intermediate transfer body.

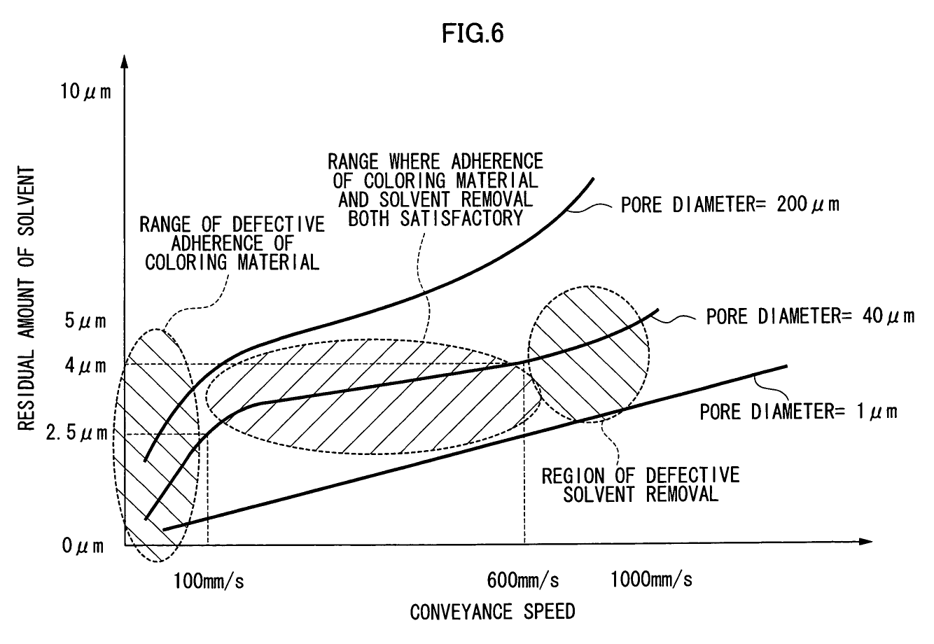

The results of the evaluation under the above described conditions are shown in Table 1. Furthermore, FIG. 6 shows a graph depicting the results relating to the residual amount of solvent.

TABLE 1

| | | Pore Diameter (μm) | | | | |
|---|---|---|---|---|---|---|
| | | 1 | 10 | 40 | 100 | 200 |
| Conveyance | 10 | D | D | D | D | D |
| Speed | 50 | D | C | C | C | C |
| (mm/s) | 100 | C | B | B | B | AF |
| | 200 | C | A | A | A | AF |
| | 600 | C | A | A | A | AF |
| | 1000 | C | AF | AF | AF | AF |

As shown in Table 1 and FIG. 6, it was confirmed that good results were obtained in terms of both adherence of coloring material and removal of solvent, when the conveyance speed of the intermediate transfer body 12 falls within the range of 100 mm/s to 600 mm/s.

Furthermore, it was also confirmed that by setting the size of the holes (pore diameter) in the solvent absorbing roller 32 to the range of 10 μm to 100 μm, good results were obtained in terms of both adherence of coloring material and removal of solvent.

Analyses of these results are described below.

### <In a Case where the Pore Diameter of the Solvent Absorbing Roller 32 is 40 μm>

In the range where the conveyance speed of the intermediate transfer body 12 is slower than 100 mm/s, the contact time between the surface of the solvent absorbing roller 32 and the coloring material becomes too long and therefore absorption of the solvent excessively progresses. Consequently, solvent ceases to be present about the perimeter of the coloring material and it is considered that the coloring material becomes more liable to adhere to the surface of the solvent absorbing roller 32, in comparison with a case where solvent is present.

On the other hand, if the conveyance speed exceeds 100 mm/s, then the contact time between the surface of the solvent absorbing roller 32 and the coloring material becomes short and the residual amount of solvent increases. Consequently, the solvent is present between the surface of the solvent absorbing roller 32 and the coloring material, and it is considered that the coloring material becomes less liable to adhere to the surface of the solvent absorbing roller 32. A similar tendency is observed until the conveyance speed of the intermediate transfer body 12 reaches 600 mm/s.

Moreover, if the conveyance speed of the intermediate transfer body 12 exceeds 1000 mm/s, the residual amount of the solvent increases further, and consequently, although adherence of coloring material ceases to occur, it is not possible to achieve the function of removing solvent, which is the original object.

### <In a Case where the Pore Diameter of the Solvent Absorbing Roller 32 is 200 μm>

In the range where the conveyance speed of the intermediate transfer body 12 is slower than 100 mm/s, adherence of coloring material occurs. On the other hand, when the conveyance speed is equal to or greater than 100 mm/s, although adherence of coloring material ceases to occur, the residual amount of solvent increases and it is not possible to achieve the function of removing solvent, which is the original object.

### <In a Case where the Pore Diameter of the Solvent Absorbing Roller 32 is 1 μm>

Adherence of coloring material occurs, irrespective of the conveyance speed of the intermediate transfer body 12. This is thought to be because the residual amount of solvent is small, and adherence of coloring material is caused by contact between the surface of the solvent absorbing roller 32 and the coloring material.

From the results described above, it is considered desirable to set the hole size (pore diameter) in the solvent absorbing roller 32 to a range of 10 μm to 100 μm, and to set the conveyance speed of the intermediate transfer body 12 to a range of 100 mm/s to 600 mm/s. In particular, when the size of the holes in the solvent absorbing roller 32 is set to 40 μm, the residual amount of solvent is virtually uniform in the conveyance speed range of 100 mm/s to 600 mm/s of the intermediate transfer body 12, as shown in FIG. 6. It is therefore desirable to set the size of the holes in the solvent absorbing roller 32 to the vicinity of 40 μm.

Next, analyses of the shape of the graph (shown in FIG. 6) of the residual solvent amount when the size of the holes in the solvent absorbing roller 32 is 40 μm.

As described above, when the conveyance speed of the intermediate transfer body 12 is in the range of 100 mm/s to 600 mm/s, the residual amount of solvent is virtually uniform.

The region where the residual amount of solvent is virtually uniform indicates the residual amount of solvent after primary absorption (first-stage absorption). In this case, the term “primary absorption” indicates solvent absorption based on the capillary action of the holes (pores) in the porous body (the solvent absorbing roller 32).

The reason why the residual amount of solvent is uniform is considered to be the following. Namely, since primary absorption by means of the capillary action of the holes in the porous body occurs instantaneously, then the residual amount of solvent is uniform provided that the conveyance speed of the intermediate transfer body 12 is within a certain range (not greater than 600 mm/s). If the conveyance speed is increased beyond this range (e.g., 1000 mm/s), then the solvent temporarily absorbed by the capillaries is drawn back again at the instant that the solvent absorbing roller 32 separates from the medium, and therefore the residual amount of solvent increases. The faster the conveyance speed of the intermediate transfer body 12, the greater the amount of negative pressure generated, and consequently, the amount of solvent drawn back also increases accordingly. The fact that the residual amount of solvent increases suddenly after the conveyance speed exceeds a certain value is thought to be because the solvent is drawn back when a negative pressure surpassing the capillary force is generated. Before the conveyance speed exceeds such a value (threshold value), no solvent is drawn back. In addition to this factor, as the conveyance speed increases, the absorption time becomes shorter, and hence there is an increase in the residual amount of solvent due to the decline in the amount of solvent absorbed.

Finally, in the region where the conveyance speed of the intermediate transfer body 12 is slow (100 mm/s or lower), it is thought that secondary absorption proceeds. Here, secondary absorption means that solvent which is in contact with a portion of the porous body other than pores (the surface of the porous body) is drawn to the pores and is absorbed into same.

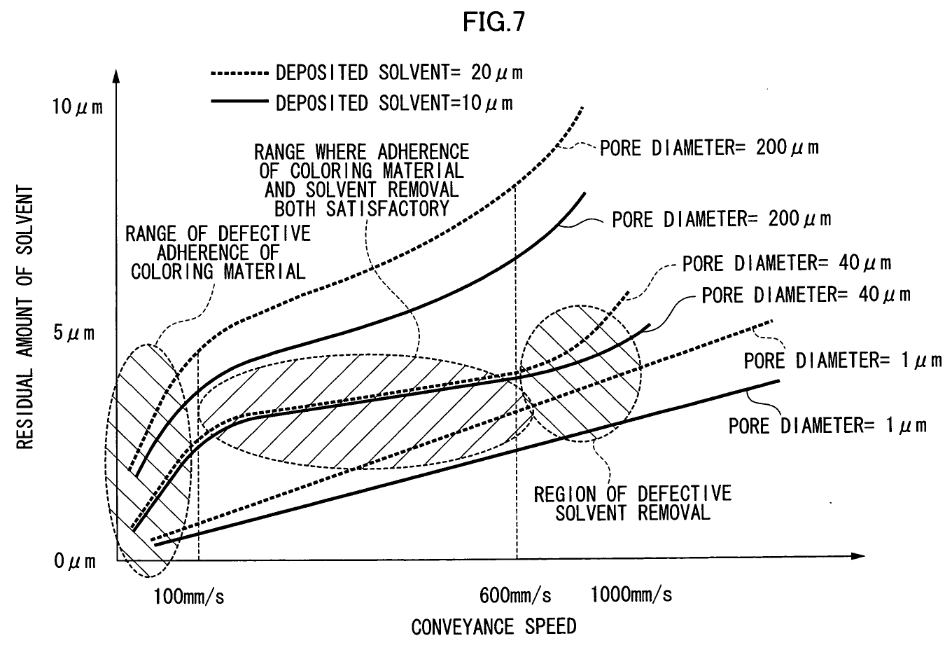

A similar experiment was carried out while changing the deposition volume (film thickness) of ink and treatment liquid (print droplet ejection volume) to 20 μm (treatment liquid film of 2.5 μm and ink film of 17.5 μm), and it was confirmed that there was no change in the region of virtually uniform residual solvent amount. In other words, as shown in FIG. 7, it was confirmed that even when the droplet ejection volume is varied, the residual amount of solvent remains virtually uniform, while the conveyance speed of the intermediate transfer body 12 is in the range of 100 mm/s to 600 mm/s.

Consequently, it was confirmed regardless of the droplet ejection volume that when the conveyance speed of the intermediate transfer body 12 is in the range of 100 mm/s to 600 mm/s, the amount of adhering coloring material can be restricted.

In this region, the residual amount of solvent and the adherence of coloring material are uniform regardless of the droplet ejection volume, and it is therefore possible to obtain a high-quality image that does not depend on the droplet ejection volume. The relationship between the image quality and the droplet ejection volume is described below.

If the residual amount of solvent changes with the droplet ejection volume, then the adherence of coloring material also varies and the image quality becomes instable depending on the droplet ejection volume. The adherence of coloring material varies in accordance with the conveyance speed of the intermediate transfer body (the contact time between the coloring material and the surface of the solvent absorbing roller) and the residual amount of solvent, and the adherence of coloring material tends to become worse when the residual amount of solvent is small (see Table 1 and FIG. 7). The change in the adherence of coloring material indicates that the amount of coloring material remaining on the recording paper deviates from an intended amount, resulting in the deterioration of the image quality (unintentional decline of image density). Since there is the above-described correlation between the residual amount of solvent and the adherence of coloring material as shown in Table 1 and FIG. 7, then, in the case where the residual amount of solvent is changed along with the image density (droplet ejection volume), the adherence of coloring material (the amount of coloring material remaining on the recording paper) accordingly changes along with the image density (droplet ejection volume), resulting in the variation of the image quality depending on the image density (droplet ejection volume). In this case, areas with sharp decline in image density and areas with little decline in image density occur: however, from the viewpoint of noticeability, the decline, if any, in image density is preferably uniform. It is therefore preferable that the conveyance speed of the intermediate transfer body 12 is set to be within the range of 100 mm/s to 600 mm/s, since the residual amount of solvent and the adherence of coloring material are uniform regardless of the droplet ejection volume as described above, and the image quality becomes stable.

Furthermore, since the actual amount of residual solvent changes, then the amount of curl of the recording medium, and the like, also varies, and therefore quality becomes instable from this viewpoint as well. In other words, if the residual amount of solvent changes along with the droplet ejection volume, the degree of curl caused by the moisture in the paper will also change, and therefore it is desirable that the residual amount of solvent be uniform, in order for the amount of curl to be uniform at all times.

Consequently, by using a range where the residual amount of solvent and the adherence of coloring material are uniform regardless of the droplet ejection volume, in other words, by using a range of 100 mm/s to 600 mm/s for the conveyance speed of the intermediate transfer body 12, it is possible to achieve image quality that does not depend on the droplet ejection volume.

Furthermore, by using a range where the residual amount of solvent and the adherence of coloring material is uniform regardless of the conveyance speed, it is possible to achieve uniform image quality, irrespective of the conveyance mode (namely, the change in conveyance speed between high-quality mode and low-quality mode).

Conditions where the residual amount of solvent varies in accordance with the droplet ejection volume include a case where the size of the pores in the porous body (solvent absorbing roller) is small, for instance. For example, if the solvent absorbing roller having a pore diameter of 1 μm is used, then the residual amount of solvent varies with the droplet ejection volume (see FIG. 7). Furthermore, the droplet ejection volume also changes with the image density.

It was confirmed that the amount of coloring material adhering to the solvent absorbing roller also varies in accordance with the ratio of the coloring material to the solvent in the ink (the content ratio between coloring material and solvent (coloring material/solvent ratio)). More specifically, when the state of adherence of the coloring material at respective conveyance speeds was evaluated, while changing the ratio of coloring material to the solvent in the ink (the content ratio between coloring material and solvent (coloring material/solvent ratio)) immediately before the ink makes contact with the solvent absorbing roller, it was confirmed that the amount of adhering coloring material changes in accordance with the ratio of the coloring material to the solvent in the ink (the content ratio between coloring material and solvent (coloring material/solvent ratio)).

The results of this evaluation are shown in Table 2. The condition for the hole size in the porous body (solvent absorbing roller) was 10 μm to 100 μm. Furthermore, the evaluation method was the same as that relating to Table 1 above.

TABLE 2

| | | Ratio of coloring material to solvent in ink | | | | |
|---|---|---|---|---|---|---|
| | | immediately before ink absorption (%) | | | | |
| | | 1 | 2 | 5 | 10 | 20 |
| Conveyance | 10 | D | D | D | D | C |
| Speed | 50 | D | C | C | C | C |
| (mm/s) | 100 | C | B | B | B | C |
| | 200 | C | A | A | A | C |
| | 600 | C | A | A | A | C |
| | 1000 | C | A | A | A | C |

In Table 2, the criteria of the evaluation are as follows.

A: 90 to 100% (adherence rate of 10% or less)

B: 80 to 90% (adherence rate of 10 to 20%)

C: 70 to 80% (adherence rate of 20 to 30%)

D: 70% or less (adherence rate of 30% or above)

From the results given above, desirably, the ratio of the coloring material with respect to the solvent in the ink (coloring material/solvent ratio) immediately before making contact with the porous body is 2% to 10%. If this ratio is 1%, then the coloring material assumes a floating state in the solvent and is separated above the ejection receiving medium, and therefore becomes more liable to adhere to the surface of the porous body. Conversely, if this ratio is 20% or above, then there arises a portion of coloring material which is liable to react with the treatment liquid, and since the unreacted ink does not aggregate, then it is liable to be absorbed into the porous body, or color becomes transferred to the surface of the porous body. In particular, in a case where the concentration of the coloring material is high, then as the solvent is absorbed, the concentration of the coloring material becomes even higher and the coloring material becomes more liable to adhere to the surface of the porous body.

Consequently, the present invention has a particularly beneficial action when the ratio of the coloring material with respect to the solvent in the ink (the coloring material/solvent ratio) immediately before making contact with the porous body (solvent absorbing roller) is in the range of 2% to 10%.

Furthermore, it was confirmed that the amount of coloring material adhering to the porous body (solvent absorbing roller) changes along with the thickness of the film formed of the treatment liquid having been deposited on the intermediate transfer body. More specifically, when the state of adherence of coloring material at respective conveyance speeds was evaluated while changing the thickness of the film formed of the treatment liquid, it was confirmed that the amount of adhering coloring material varies in accordance with the thickness of the film formed of the treatment liquid. Table 3 shows the results of this evaluation. The size of the holes in the porous body (solvent absorbing roller) was 10 μm to 100 μm. Furthermore, the evaluation method was the same as that in Table 1 described above. The film thickness of the ink liquid was set to 7.5 μm. Table 3 shows not only the ratio of the film thickness of the treatment liquid to the film thickness of the ink, but also the approximate value of the film thickness of the treatment liquid (i.e., 1 μm, 2 μm, 7.5 μm, and 15 μm).

TABLE 3

| | | Ratio of film thickness of treatment liquid to ink | | | |
|---|---|---|---|---|---|
| | | 10% | 25% | 100% | 200% |
| | | approximately | approximately | approximately | approximately |
| | | 1 μm | 2 μm | 7.5 μm | 15 μm |
| Conveyance | 10 | D | D | D | D |
| Speed | 50 | D | C | C | D |
| (mm/s) | 100 | D | A | B | C |
| | 200 | D | A | B | C |
| | 600 | D | A | B | C |
| | 1000 | D | A | B | C |

In Table 3, the criteria of the evaluation are as follows.

A: 90 to 100% (adherence rate of 10% or less)

B: 80 to 90% (adherence rate of 10 to 20%)

C: 70 to 80% (adherence rate of 20 to 30%)

D: 70% or less (adherence rate of 30% or above)

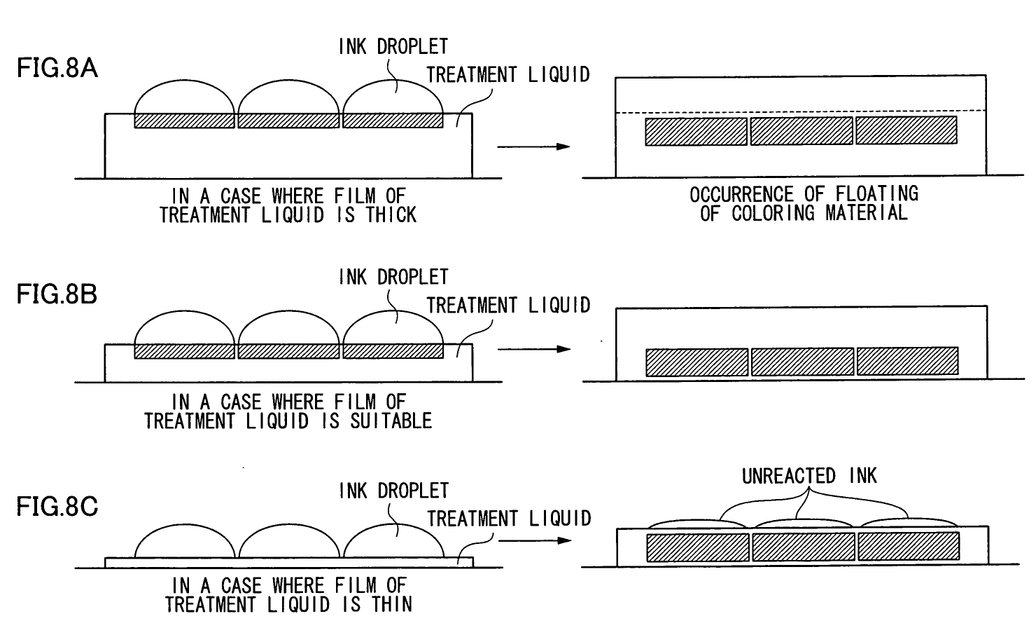

From the foregoing results, desirably, the film thickness of the treatment liquid is approximately 25% to 100% with respect to the film thickness of the ink. If the film of the treatment liquid is too thick, then the coloring material assumes a floating state in the solvent and is separated above the ejection receiving medium, and therefore becomes more liable to adhere to the surface of the porous body (see FIG. 8A). Conversely, if the ratio is 10% or less, then the upper portion of the ink will not react with the treatment liquid, and the coloring material becomes more liable to make contact with the ejection receiving medium and to adhere to the surface of the porous body (see FIG. 8C).

Therefore, the present invention has an especially beneficial action in cases where the treatment liquid is deposited to a thickness of 3 μm to 10 μm on the recording surface of the intermediate transfer body 12 (see FIG. 8B).

In order to suppress the adherence of coloring material to the surface of the porous body, it is desirable that the solvent having at least a film thickness substantially the same as the film thickness of the deposited treatment liquid (in this case, “substantially the same thickness” indicates range of approximately ±10% with respect to the thickness of treatment liquid) be left remaining on the recording medium after absorption of solvent by the porous body (in other words, the solvent absorption is carried out so that, after the solvent absorption, the solvent remains at a thickness ranging between a thickness substantially equal to the thickness of the deposited treatment liquid, and a thickness equivalent to the thickness of the total amount of solvent deposited (the total amount of solvent of the ink and the treatment liquid)).

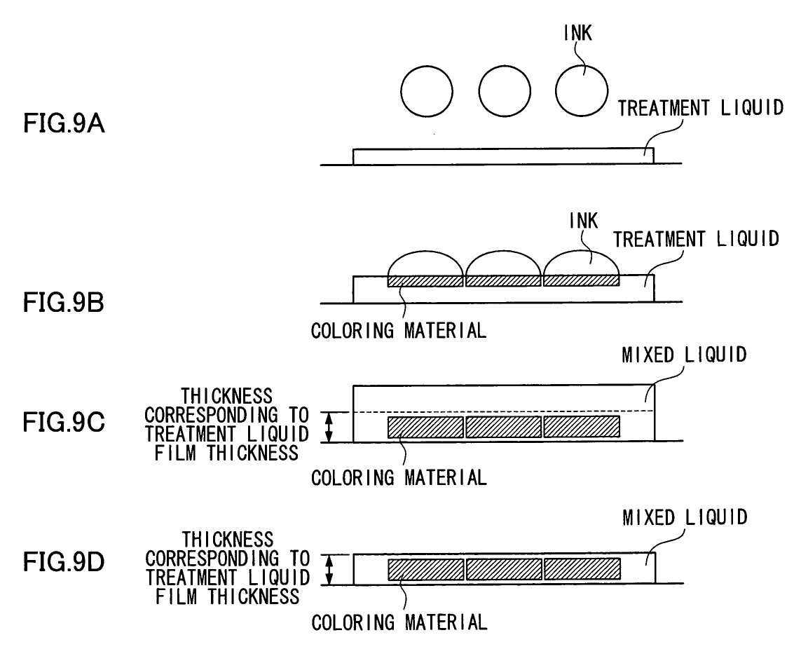

FIGS. 9A to 9D are diagrams showing the relationship between the residual amount of solvent and the adherence of coloring material to the surface of the porous body. As shown in FIG. 9A, ink droplets are ejected from the recording head toward the ejection receiving medium on which the film of the treatment liquid has been formed. The ink droplet containing the coloring material starts to react with the treatment liquid at the vicinity of the interface between the ink droplet and the film of the treatment liquid, resulting in the creation of the aggregate of the coloring material, as shown in FIG. 9B. Thereupon, the coloring material collect to make up the aggregate through the aggregation reaction, and the liquid component (ink solvent) of the ink is mixed with the liquid component (treatment liquid solvent) in the treatment liquid. In other words, the interface between the ink and the treatment liquid is eliminated after mixed with each other, and the film of the mixed liquid of the ink and the treatment liquid is formed, as shown in FIG. 9C. Finally, the excess solvent in the mixed liquid is absorbed by the solvent removal unit 18, and the solvent having a film thickness corresponding to the treatment liquid film thickness remains on the ejection receiving medium, as shown in FIG. 9D.

As described above with reference to FIGS. 9A to 9D, when ink droplets are deposited on the ejection receiving medium on which treatment liquid has been deposited, then the coloring material in the ink reacts with the treatment liquid and assumes an aggregated state where the aggregate of the coloring material is separated from the liquid component (solvent) derived from the ink and the treatment liquid. When the solvent is subsequently absorbed by the porous body, if too much of the solvent is absorbed, then adherence of coloring material occurs (see FIG. 6). Therefore, a certain amount of solvent is preferably left on the recording medium, and it is sought to achieve a good balance between adherence of coloring material and absorption of solvent. Therefore, in order to suppress adherence of coloring material, it is preferable that the solvent corresponding to a film thickness of the treatment liquid remain after the solvent absorption, since the majority of the coloring material is present in the treatment liquid after reacting with the treatment liquid.

Accordingly, when removing solvent, it is desirable that excess solvent be removed by means of a porous body, in such a manner that solvent is left on the recording medium to a thickness that is at least equal to the thickness of the deposited treatment liquid.

For example, in the case of FIG. 6, it is possible to suppress adherence of coloring material to the surface of the porous body by causing the solvent film having a thickness of at least 2.5 μm (the thickness of the treatment liquid as initially formed by droplet ejection) to remain on the ejection receiving medium after the solvent absorption.

In the present embodiment, the contact time between the porous body (solvent absorbing roller) and the ink is changed by altering the conveyance speed of the recording medium, but it is also possible to change the contact time between the porous body and the ink by altering the outer diameter (circumferential diameter) of the porous body (solvent absorbing roller). Consequently, it is thought that beneficial effects similar to those described above can be obtained by reducing the outer diameter of the solvent absorbing roller 32, while maintaining the same conveyance speed of the intermediate transfer body 12. However, if the outer diameter of the solvent absorbing roller 32 is reduced, then the angle of introduction of the intermediate transfer body 12 with respect to the solvent absorbing roller 32 becomes larger and disturbance of the coloring material occurs. Therefore, it is desirable to shorten the contact time by means of the conveyance speed of the intermediate transfer body 12 rather than the outer diameter of the porous body.

Furthermore, by raising the conveyance speed of the intermediate transfer body 12, it is possible to shorten the time from the deposition of ink until the ink makes contact with the solvent absorbing roller 32, and consequently movement of the coloring material, and the like, can be suppressed. In other words, since, after the ink deposition, the coloring material floats in the solvent and assumes a highly instable state and the coloring material may be disturbed from its depositing position with the passage of time, then it is desirable to remove the solvent as soon as possible so that such movement of the coloring material is suppressed.

Furthermore, there is another beneficial effect when the solvent is removed as soon as possible. For example, in a case where the ejection receiving medium having high permeability on which ink is deposited is used, it is possible to remove the solvent while the amount of the permeation is small, and therefore ink bleeding can be prevented effectively.

In the present embodiment, a composition is adopted in which an intermediate transfer type of inkjet recording apparatus is used, but the application of the present invention is not limited to this. In other words, the present invention can also be applied similarly to an inkjet recording apparatus using a method for recording images by ejecting ink directly toward the recording medium. In the case of such an image forming apparatus of direct type, the term “ejection receiving medium” indicates a recording medium, such as a paper.

Furthermore, in the present embodiment, a composition is adopted in which excess solvent is removed by placing the solvent absorbing roller 32 in contact with the ink deposited on the recording surface of the intermediate transfer body, but the member for absorbing the excess solvent, in other words, the composition of the liquid absorbing member is not limited to this. For example, it is also possible to remove excess solvent by means of a composition in which a liquid absorbing member made of a porous material and formed in an endless belt shape is wound about a pair of rollers. In this composition, the endless belt-shaped liquid absorbing member is caused to come into contact with ink deposited on the recording surface of the intermediate transfer body, thereby removing the excess solvent. Apart from this, it is also possible to remove excess solvent by means of a composition in which the liquid absorbing member is formed in a belt-shape and made of a fibrous body or porous body. In this composition, the belt-shaped liquid absorbing member is caused to come into contact with the ink deposited on the recording surface of the intermediate transfer body while the belt-shaped liquid absorbing member is winded onto one roller from another roller.

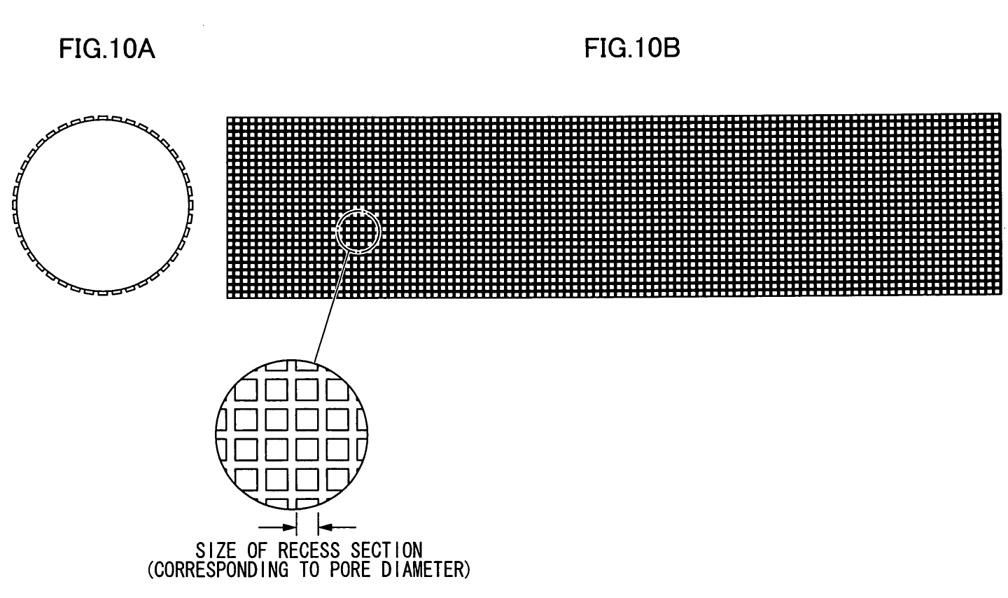

Furthermore, the porous material used as the liquid absorbing member may be composed so as to absorb solvent by means of capillary action, and apart from a sponge type of material, it is also possible to adopt a composition which the surface of the material has undulations. Therefore, as shown in FIGS. 10A and 10B, for example, it is possible to use a roller having surface undulations composed of recesses and projections as a solvent absorbing roller. In this case, the size of the recess sections is equivalent to the pore diameter, and the size of the recess sections is therefore set to a range of 10 μm to 100 μm. In the example shown in FIGS. 10A and 10B, the recess sections are formed in a square shape, but the shape of the recess sections is not limited to this. Furthermore, it is also possible to form the recess sections to a prescribed depth, or to form them so as to penetrate into the interior of the roller.

Moreover, there are no particular restrictions on the ink and the treatment liquid used, and it is possible to use ink containing, for example, water forming a solvent, together with a surfactant, a water-soluble solvent, a coloring material (pigment), and it is possible to use treatment liquid containing, for example, water forming a solvent, together with a surfactant, a water-soluble solvent, and a coloring material aggregating agent. For the coloring material aggregating agent, it is possible to use a pH adjuster or a multivalent metallic salt. As a material for the pH adjuster, it is possible to use an inorganic acid (nitric acid, sulfuric acid, phosphoric acid, or the like) or an organic acid (desirably, an acid containing carboxylic acid, sulfone acid, or the like, and more specifically, acetic acid, methane sulfonic acid, or the like). As the multivalent metallic salt, it is possible to use various multivalent metallic ions, aluminum, magnesium, iron, zinc, tin, and the like.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. An image forming apparatus, comprising:
a conveyance device which conveys an ejection receiving medium along a prescribed conveyance path;
a recording head which deposits ink on the conveyed ejection receiving medium to form an image, the ink containing solvent and coloring material; and
a liquid absorbing member which is made of a porous body having pores, the liquid absorbing member coming into contact with the ink deposited on the ejection receiving medium so that an excess of the solvent is removed, wherein:
the conveyance device conveys the ejection receiving medium at a conveyance speed from 100 mm/s through 600 mm/s while the liquid absorbing member is in contact with the deposited ink; and
the pores of the liquid absorbing member has a pore diameter from 10 μm through 100 μm.

2. The image forming apparatus as defined in claim 1, wherein a percentage of the coloring material to the solvent is within a range of 2% through 10% in the ink before the liquid absorbing member comes into contact with the ink.

3. The image forming apparatus as defined in claim 1, further comprising a treatment liquid deposition device which deposits treatment liquid on the conveyed ejection receiving medium to form a film of the treatment liquid, the treatment liquid causing the coloring material in the ink to be aggregated, the film of the treatment liquid having a thickness of 3 μm through 10 μm.

4. The image forming apparatus as defined in claim 3, wherein the liquid absorbing member removes the excess of the solvent of the ink and the treatment liquid so that, after removing the excess of the solvent, the solvent remains on the ejection receiving medium to form a film having a thickness not less than the thickness of the film of the treatment liquid.
